(19) United States
(12) Patent Application Publication
(10) Pub. No.: US 2026/0296886 A1
(43) Pub. Date: Oct. 1, 2026

(54) An ozone generator comprising cooling means for generating ozone, a method for generating ozone from an oxygen rich gas and use of the generator

(71) Applicant: WATER APS, Farum (DK)

(72) Inventor: Richard Ailwyn Martin, Praesto (DK)

(21) Appl. No.: 19/489,415

(22) PCT Filed: May 29, 2024
(86) PCT No.: PCT/EP2024/064798

§ 371 Date: Dec. 2, 2025

(30) Foreign Application Priority Data
Jun. 6, 2023 (DK) PA202330067

(51) Int. Cl. C01B 13/11; B01J 19/08

(52) U.S. Cl. CPC C01B 13/115; B01J 19/088; B01J 2219/0809; B01J 2219/0849; B01J 2219/0869; B01J 2219/0871; C01B 2201/64; C01B 2201/72

(57) ABSTRACT

An ozone generator (1) for generating ozone includes high voltage electrode (HVE) (2) a low voltage electrode (LVE) (3) a dielectric (4,4a,4b) and an electric isolator (25,25a,25b).

The generator (1) also includes at least one inlet gas port (5,5a,5b) and at least one inlet duct (12,12a, 12b) for leading oxygen rich gas into the generator (1) to a corona chamber (11,11a, 11b), and one outlet gas port (6) for leading generated ozone gas out of the generator (1).

The LVE (3) includes integrated cooling channels (19) for cooling the ozone gas, and at least on one surface of the LVE (3) a periphery placed outlet recess (14,14a, 14b) is established in a distance from the inlet duct (12,12a, 12b). It encircles the inlet duct (12,12a, 12b) in its entire circumference and guides the ozone gas to the outlet gas port (6) placed in the cooled LVE (3).

The present invention relates to an ozone generator for generating ozone comprising at least one high voltage electrode (HVE) having a first HVE surface, an opposite second HVE surface;
one low voltage electrodes (LVE), comprising a first LVE surface and an opposite second LVE surface,
the generator further comprises at least one dielectric and at least one electric isolator,
the generator further comprises at least one inlet gas port and at least one inlet duct for leading oxygen rich gas into the generator and one outlet gas port for leading generated ozone gas out of the generator,
the generator further comprises at least one corona chamber placed between the dielectric and the HVE and adapted to develop ozone,
the at least one dielectric comprises a first surface turning towards the first HVE-surface and an opposite second surface is turning towards the LVE surface, the oxygen is led through the inlet gas port to the inlet duct,
the LVE comprises integrated cooling channels for cooling the ozone gas.

The invention further comprises a method for generating ozone from an oxygen rich gas by leading the oxygen rich gas into an ozone generator comprising at least one high voltage electrode (HVE) having a first HVE surface, an opposite second HVE surface;
one low voltage electrodes (LVE), comprising a first LVE surface and an opposite second LVE surface,
the generator further comprises at least one dielectric and at least one electric isolator,
the generator further comprises at least one inlet gas port and at least one inlet duct for leading oxygen rich gas into the generator, and one outlet gas port for leading generated ozone gas out of the generator,
the generator further comprises at least one corona chamber developing ozone placed between the dielectric and the HVE,
the at least one dielectric comprises a first surface turning towards the first HVE-surface and an opposite second surface is turning towards the first LVE surface, the oxygen is led through the inlet gas port to the inlet duct, and the LVE comprises integrated cooling channels for cooling the ozone gas.

Finally, the invention relates to use of the ozone generator according to the invention for performing the method according to the invention.

The abbreviation “HVE” is throughout the document used for high voltage electrode and the abbreviation “LVE” is throughout the document used for low voltage electrode. The low voltage electrode is earth electrode.

Ozone is a very powerful, gaseous reactant, and its usefulness has been well established for many years in a wide range of industrial applications. Its value in all types of water purification applications has been coming to the fore because of its ability to act as a powerful oxidant, micro flocculants and disinfectant without producing toxic side-products.

It can destruct or remove for example complex organic molecules, cyanides and phenols from chemical waste, waste from paper plants and dye-mills, surfactants and detergents from washing processes, odors from wastewater plants.

Ozone is further used for pretreating drinking water, enhancing its quality considerably. Ozone is also used for bleaching pulp in the paper making industry.

It is well known that ozone is generated by so-called dark or cold electrical discharges in oxygen gas or oxygen-rich gas mixtures. Presently known devices for generating ozone in satisfactory quantities and concentrations for industrial applications, however, are very voluminous and are difficult and expensive to service.

The most widely used method of generating ozone is to flow dry air or oxygen through a narrow gap bordered on one side by a conductive electrode and on the other side by another electrode. An alternating high voltage is connected across the electrodes, producing a high voltage field across the gap, which creates a corona discharge. This discharge (cold plasma discharge) converts a percentage of the oxygen rich gas to ozone. A dielectric is necessary to prevent arcs between the conductive electrodes, which would rapidly destroy the electrode surfaces.

GB 854616 A describes a plate-type ozone generator producing ozone by continuous silent electric discharges between flat electrodes having a stabilizing dielectric layer interposed between them. It comprises electrodes and dielectric layers formed as annular discs and arranged as a plate battery in a metallic tube having a cooling jacket, alternate electrodes having their circumferences in heat-conducting contact with the tube. The gas to be ozonized is introduced through a central aperture of the discs and the ozone gas leaves the generator through an outlet opening formed as a ring-formed chamber enclosing the discs and dielectrics.

Since the dielectric plates further comprise a hole, the area of the active surface is reduced, as well as the mechanical properties of the dielectric plate are weakened. A dielectric is a very brittle material, and a hole through it reduces its mechanical properties. In addition, there is a risk of a short circuit between the free edge-hole of the dielectric and the high-voltage electrode.

U.S. Pat. No. 6,726,885 A describes an ozone generator where oxygen is led into the corona camber in the periphery and leaves the generator through a duct placed in the middle of the generator. The generator comprises two LVE that are cooled by chambers placed at the outer surface of the LVE turning away from corona chamber. The cooling effect is in this way less effective and there is a risk for decay of the produced ozone whereby the effect of the generator is reduced.

DK 180586 B describes an ozone generator where the oxygen is led into a central aperture of the corona chamber and leaves the corona chamber in the periphery. The construction requires the ozone gas to pass through at least two chambers. The more chambers the greater risk for leakage. Further the cooling of the generator could be more effective.

With other words, it is desirable to be able to provide an ozone generator where high possible energy density is obtained without raising the operating temperature and reducing the numbers of chambers for the ozone gass to pass.

As the surface temperature of the plates turning towards the corona chamber is significantly reduced the generator can work with and under high pressure. Further, it is desirable that the generator has a high efficiency and produces large quantities of ozone. Further, it is possible to decrease the size of the generator—other things being equal—since the generation of ozone can be increased due to the construction and cooling of the generator. The generator according to the invention does only need one LVE—cooled with channels placed inside the LVE. As only one LVE is used and the ozone gas leaves the generator through the LVE, the number of chambers inside the generator is reduced thereby reducing the risk of leak.

The present invention seeks generally to improve an ozone generator device such that the abovementioned insufficiencies and drawbacks of today's ozone generators are overcome or at least it provides a useful alternative. Up to this day, prior art has failed to teach a simple and yet reliable and inexpensive ozone generator which in a safe and reliable manner, without substantially increasing the cost of the device, is able to satisfy the abovementioned much desired characteristics of the mentioned ozone generator. The generator is suitable for withstanding high internal pressures and up to at least 8-10 bars. Hereby the scope of application for the generator is increased.

According to the invention, a generator is provided, as per the introductory part of this specification, and wherein the inlet duct ending in a center portion of the corona chamber and at least one surface of the LVE comprises one in the periphery placed outlet recess, which faces in the same direction as the first surface of the dielectric, the outlet recess(es) placed in a distance from the inlet duct and encircling the inlet duct in its entire circumference, and the at least one outlet recess is adapted to guide the ozone gas to the outlet gas port placed in the cooled LVE.

The generator is preferably made of flat elements. The dielectric is a flat device preferably a ceramic plate with a uniform thickness of 500-700 μ. The LVE is also quite flat constructed with a surface turning towards the interior of the generator. The surface is supporting the dielectric. The LVE has a flat, smooth, and even LVE surface in the area where the dielectric is placed. The generator may comprise one or two HVE and one or two dielectrics. The gap for producing ozone is at one side delimited by a HVE surface and at the other side delimited by the dielectric.

The gas is led into the center of the corona chamber and from here, it flows to the periphery and leaves the corona chamber through an outlet recess placed in the surface of the LVE. From here, it leaves the generator through an outlet gas port placed in the LVE. The LVE is cooled by integrated cooling channels. That is the cooling channels are channels placed inside the LVE and may be provided during drilling of the channels in the LVE. In the channels cooled air, water or liquid cooling is flowing. The outlet recess contributes to the cooling effect together with the outlet gas port placed in the cooled LVE. Due to the construction comprising the outlet recess, the ozone gas only passes through one chamber reducing the risk for leak.

Before oxide-rich gas is supplied to the construction, a high voltage—up to 25 kV—is applied to the electrodes. When the oxide reaches the corona chamber with high voltage applied, the oxygen is converted to ozone. The produced ozone leaves the generator through the outlet port.

The dielectric is positioned between one LVE and one HVE, and the corona chambers are always positioned on the LVE and delimited at one site by the LVE supporting the dielectric and at the other side by the HVE.

It is important that the dielectric is supported in its full extension by the LVE directly or indirectly. When indirectly supported an electrically conductive material can be placed between the two components. Due to the support of the fragile ceramic plate, it will not crack and the generator is suitable for use under high pressure loads. The LVE is a ground electrode.

The abbreviation “LVE” is in the whole document used for low voltage electrode and the abbreviation “HVE” is used for high voltage electrode.

According to one embodiment, the at least one outlet recess is a circular closed first recess encircling the inlet duct(s) and placed with a radius R from the center of the inlet duct(s).

The recess is formed circular with the same distance throughout its circumference to the inlet duct in order to provide a uniform departure of the ozone gas. The outlet recess is closed at the top by the installation of the isolator closing the generator in the periphery. The outlet recess contributes to management placement of the dielectric.

According to one embodiment, the surface(es) of the LVE turning towards the HVE is/are in an inside-area placed inside the outlet recess lowered in relation to an area placed outside the outlet recess, and the dielectric covers the entire said inside-area.

The inside area of the LVE is supporting the dielectric in it s full extension. This is important in order to avoid cracking of the dielectric. The lowering of the LVE makes space to the dielectric and to the corona chamber where the ozone is produced.

According to one embodiment, the inside area(s) is/are a circular lowered area corresponding to the extension of the dielectric(s), whereby the dielectric(s) is/are fully supported throughout its/their extent.

It is advantageous to design the dielectric circular and as a consequence the lowered area must also be circular.

According to one embodiment, an inside edge is delimiting the inside area(s) towards the outlet recess, and openings in the inside edge are providing a gas communication between the inside area(s) and the outlet recess(es). This construction provides a closed corona chamber in the periphery with openings in the edge for letting the produced ozone gas escape the corona chamber.

According to one embodiment, a communication channel placed in the at least one outlet recess connects the outlet recess(es) with the outlet gas port.

According to one embodiment, a seal recess is encircling the outlet recess(es), and a sealing member is placed in said seal recess(es). The sealing member sees to that the generator does not leek.

According to one embodiment, the sealing member(s) is/are an O-ring with a circumferential opening in the surface communicating with a substantially cylindrical inner cavity, in said cavity a metallic ring is placed.

The generator may work during great pressure. The ordinary O rings made of Teflon® are sufficient to withstand a low pressure, but during the high pressure there may be a risk that the generator would leak as the Teflon® may decompose. When constructing an O-ring using ozone-resistant Teflon® comprising a ring of metal—preferably of steel—placed inside a circular cavity of the O ring the inventive O ring can withstand the influence from the ozone.

According to one embodiment, the seal recess(es) is/are a circular enclosed recess(es) delimited from the outlet recess(es) by a seal edge.

The circular seal edge contributes to the protection of the sealing against decomposition.

According to one embodiment, is/are the corona chamber(s) adapted to maintain a high voltage between one HVE and the LVE, and that a high voltage is applied to the at least one HVE by an electrical connection—such as a wire—to a connector part of said HVE.

According to one embodiment is/are the second surface of the dielectric(s) directly or indirectly supported in its/their full extension by the LVE-surface(s), and that the dielectric(s) is/are a continuous unbroken plate(s).

According to one embodiment the HVE(s) comprise(s) a circumferential edge delimiting the extension of the HVE(s), and that the dielectric(s) comprise(s) a circumferential edge delimiting the extension of dielectric(s), and the delimiting edge of the dielectric(s) in the whole periphery extends all over the delimiting edge of the HVE(s).

By this construction the risk of short circuit is reduced.

According to one embodiment the at least one corona chamber is/are delimited at one side by the at least one dielectric placed on the cooled LVE and at the opposite side by the HVE, and at the periphery by an edge with openings said edge is an integrated part of the cooled LVE.

According to one embodiment that the generator comprises one HVE, one dielectric, one corona-chamber, one LVE, one inlet gas port, one inlet duct, one electric isolator and one outlet gas port, said the LVE comprises integrated cooling channels for cooling the ozone gas, and one surface of the LVE comprises one in the periphery placed outlet recess placed in a distance from the inlet duct and encircling the inlet duct in its entire circumference, and the outlet recess is adapted to guide the ozone gas to the outlet gas port placed in the cooled LVE.

This is the simplest generator according to the invention comprising only one HVE and thereby only one corona chamber with the technical features necessary for proving one corona chamber.

According to one embodiment the generator comprises two HVE a first HVE and a second HVE and two dielectrics a first dielectric and a second dielectric, two inlet gas ports a first inlet gas port and a second inlet gas port for leading oxygen rich gas into each of its corona chamber a first corona chamber and a second corona chamber,
two electric isolators a first isolator and a second isolator, and one LVE,
the LVE comprises integrated cooling channels for cooling the ozone gas and the surfaces of the LVE—the first LVE surface and the opposite placed second LVE surface—each comprising a peripheric placed outlet recess—a first outlet recess and a second outlet recess—placed in a distance from each inlet duct—a first inlet duct and a second inlet duct—each encircling the inlet ducts in their entire circumferences and for guiding the ozone gas to the outlet gas port placed in the cooled LVE.

In this case the generator may produce twice as much ozone as compared with the generator comprising one HVE.

The invention also concerns a method as cited in the introduction, where the gas is flowing from a center to the periphery of the corona chamber, gas is flowing through one in the periphery placed outlet recess placed in a distance from the inlet duct in at least one of the surfaces of the LVE—the first and the second LVE surface—and encircling the inlet duct in its entire circumference, and whereby the ozone gas is guided to the outlet gas port placed in the LVE, said LVE including the outlet recess(es) are cooled by the cooling channels integrated in the LVE by said cooling the leaving ozone gas is cooled.

According to one embodiment the gasflow in the outlet recess(es) flows circular encircling the inlet duct(s) and the circular gasflow is placed in a radius R from the center of the inlet duct(s).

According to one embodiment the gas flows from an inside-area placed inside the outlet recess(es) through openings placed in an inside edge delimiting the inside-area(s) and from here flows towards the outlet recess(es).

According to one embodiment the gas flows form the outlet recess(es) to a communication channel connecting the outlet gas port with a bottom of the outlet recess(es).

According to one embodiment, the LVE is a ground electrode and made in pure aluminum and that the HVE(s) also is/are made in pure aluminum.

According to one embodiment, the gas led into the generator comprises pure oxygen or air or a combination thereof.

According to one embodiment, the dielectric is a coating coated on at least one of the LVE surfaces.

According to one embodiment, ring formed seal(s) such as O-rings is/are placed between the surface(s) of the isolator turning towards the HVE(s) and the respective surface(s) of the HVE(s), said seal(s) is/are placed in the periphery.

### BRIEF DESCRIPTION OF THE DRAWINGS

FIG. 1 is an exploded and sectional view of the components for a first embodiment of an ozone generator according to the invention comprising one HVE.

FIG. 2 is a perspective of the LVE electrode according to the invention comprising cooling channels (not seen).

FIG. 3 is a sectional view of the LVE shown in FIG. 2 and showing the cooling channels.

FIG. 4 is a perspective and sectional view of the first embodiment of an ozone generator according to the invention.

FIG. 5 is a sectional view of the generator shown in FIG. 4 and partly exploded view.

FIG. 6 is an enlarged section of an outlet area for the ozone gas for the first embodiment.

FIG. 7 is showing the flow of a gas through a generator according to the first embodiment.

FIG. 8 is an exploded and sectional view of the components for a second embodiment of an ozone generator according to the invention comprising two isolators and two HVE.

FIG. 9 is a sectional view of the LVE shown in FIG. 8

FIG. 10 is a perspective view of the second embodiment of an ozone generator according to the invention

FIG. 11 is a sectional view of the generator shown in FIG. 10 and partly exploded view

FIG. 12 is an enlarged section of the outlet area for the ozone gas for the second embodiment.

FIG. 13 is showing the flow of a gas through a generator according to the second embodiment.

FIG. 14 is a sectional view through an O-ring used for sealing the generator according to the invention.

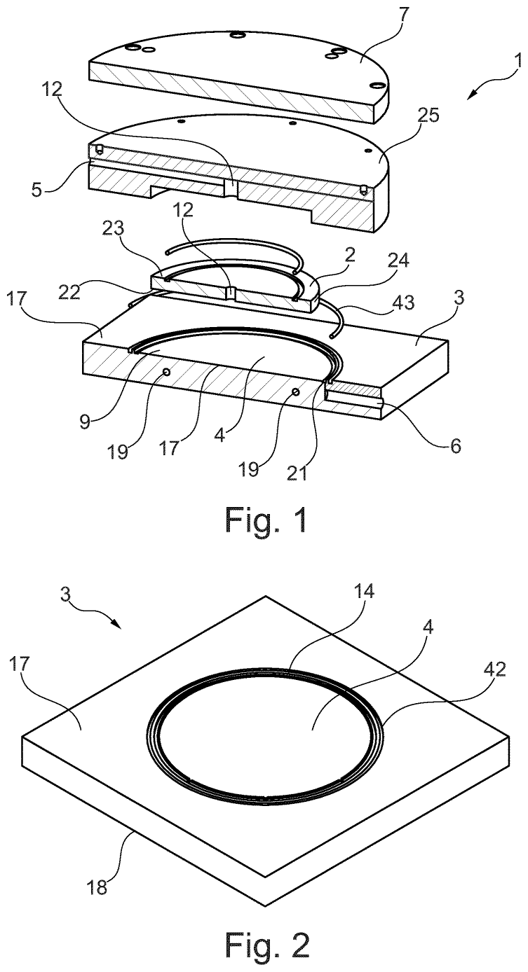

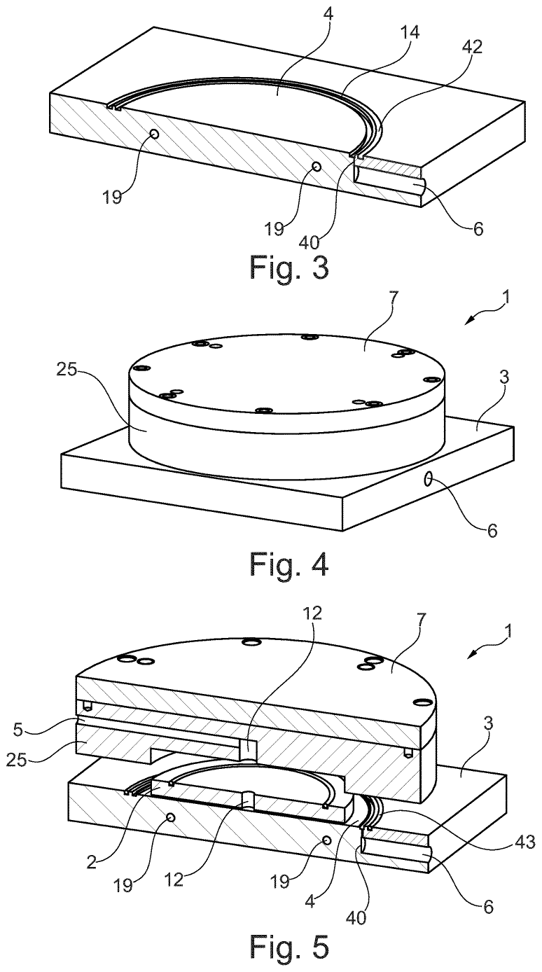

The first embodiment of the invention will be explained with reference to FIG. 1-6. FIG. 1 shows an explode view of an ozone generator 1 according to the invention comprising an isolator 25 made in a non-conductive material such as thermoplastic materials. A suitable material is polytetrafluoroethylene (PTFE) also called Teflon®. At one side of this a low voltage electrode 3 is placed and at the other side a lid 7 is attached. The generator 1 is assembled with screws through the lid 7 and attached to the LVE 3. The low voltage electrode 3 is advantageously made in pure aluminum and is flat plate shaped. A dielectric 4 is covering a central part of the LVE 3.

Between the isolator 25 and the LVE 3/the dielectric 4 a high voltage electrode (HVE) 2 is placed. The surface of the HVE 2 turning away from the isolator 25—the first HVE surface 22 of the HVE—is facing first surface 9 of a dielectric 4, which in this case is a flat circular plate with a thickness in the interval of 500-700 μ. It is made in a material such a ceramic (Al₂O₃), Teflon®, glass or another non-conductive material.

The ozone generator 1 for generating ozone comprises in this embodiment one high voltage electrode 2 having the first HVE surface 22, an opposite second HVE surface 23 and one low voltage electrodes (LVE) 3, comprising a first LVE surface 17 and an opposite second LVE surface 18. It further comprises one dielectric 4 and one electric isolator 25. Through an inlet gas port 5 placed in the isolator 25 and an inlet duct 12 ending in the middle of a corona chamber 11 and placed in the isolator 25 and the HVE 2, oxygen rich gas is led into the generator 1.A tube connected to a fitting placed in the inlet duct 12 is housed in the inlet gas port 5 and leading the gas into the generator 1. The tube is preferably made of Teflon®. An outlet gas port 6 leads generated ozone gas out of the generator 1. The corona chamber 11 is placed between the dielectric 4 and the HVE 2. The ozone is developed in this chamber.

The dielectric 4 comprises the first surface 9 turning towards the first HVE-surface 22 and an opposite second surface turning towards the first LVE surface 17, the oxygen is led through the inlet gas port 5 to the inlet duct 12 ending in a center portion 13 of the corona chamber 11. See FIG. 7

As can be seen the components of the generator 1 is circular shaped but could be made in any shape such as square or rectangular etc. The HVE 2 is bounded by a peripheral edge 24 and the dielectric 4 is bounded by a peripheral edge 21. When the components are circular shaped the diameter of the dielectric 4 is larger than the diameter of the HVE 2. The surface of the dielectric 4 turning away from the HVE 2—the second surface—is facing and directly or indirectly in its full extension resting against a surface of the first LVE surface 17 of the LVE 3.

The LVE 3 comprises integrated cooling channels 19 for cooling the ozone gas, and the surface of the LVE 3 turning towards the HVE 2 comprises two in the periphery placed outlet recesses an outlet recess 14 and a seal recess 42—see FIG. 2,3,5,6—placed in a distance from the inlet duct 12 and encircling the inlet duct 12 in its entire circumference. The outlet recess 14 guides the ozone gas to the outlet gas port 6 placed in the cooled LVE 3.

A communication channel 40 is placed in a bottom 41 of the outlet recess 14 and connects the outlet recess 14 with the outlet gas port 6.

The seal recess 42 is encircling the outlet recess 14 and a sealing member is placed in said seal recess 42. This is shown in FIG. 5.

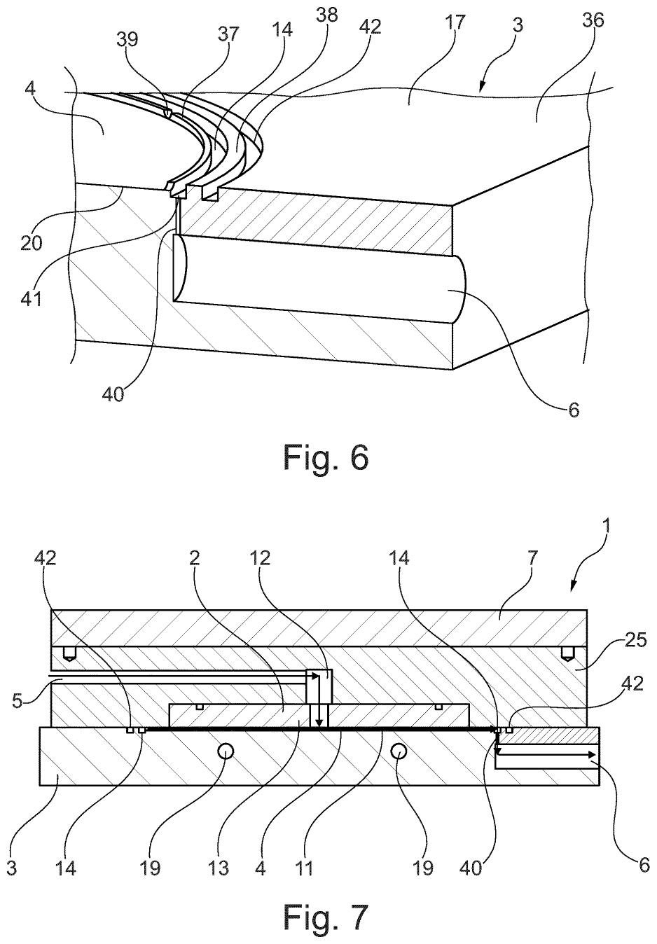

The outlet recess 14 is a circular closed recess encircling the inlet duct 12 and placed with a radius R from the center of the inlet duct 12. The outlet recess 14 is open at the top but closed by the isolator 25 covering the top-opening of the outlet recess 14. See FIG. 7. A surface area of the surface 17 of the LVE 3 turning towards the HVE 2 is in an inside-area 20 placed inside the outlet recess 14 and is lowered in relation to an area 36 placed outside the outlet recess 14. It is clearly seen in FIG. 6. The dielectric 4 covers the entire inside-area 20. The inside area 20 is a circular lowered area corresponding to the extension of the dielectric 4. The dielectric is fully supported throughout its extent.

A inside edge 37 is delimiting the inside area 20 towards the outlet recess 14. Openings 39 in the inside edge 37 are providing a gas communication between the inside area 20/corona chamber 11 and the outlet recess 14. 4-8 openings 39 are provided.

The seal recess 42 is a circular enclosed recess delimited from the outlet duct 14 by a seal edge 38 and encircling the outlet recess 14.

Referring to FIG. 7 the flow of the gas will be explained. The oxygen rich gas is led into the inlet gas port 5 and directed to the inlet duct 12 to the middle of the corona chamber 11. The gas is now flowing from the center to the periphery of the corona chamber 11 where it escapes though openings 39 in the inside edge 37 to the outlet recess 14. From here it is led through the communication channel 40 to the outlet gas port 6 placed in the cooled LVE 3.

The generator is sealed with O-rings placed in recesses. One of them being the seal recess 42 with an O-ring 43. Another seal is between the HVE 2 and the isolator 25. A circular recess is placed in the surface of the HVE 2 and an O-ring is pressed into the recess for sealing. This is seen in FIGS. 1 and 5.

The electricity is led to a connector part of the HVE 2 through an opening in the isolator 25. A high voltage between the HVE 2 and the LVE 3 is established.

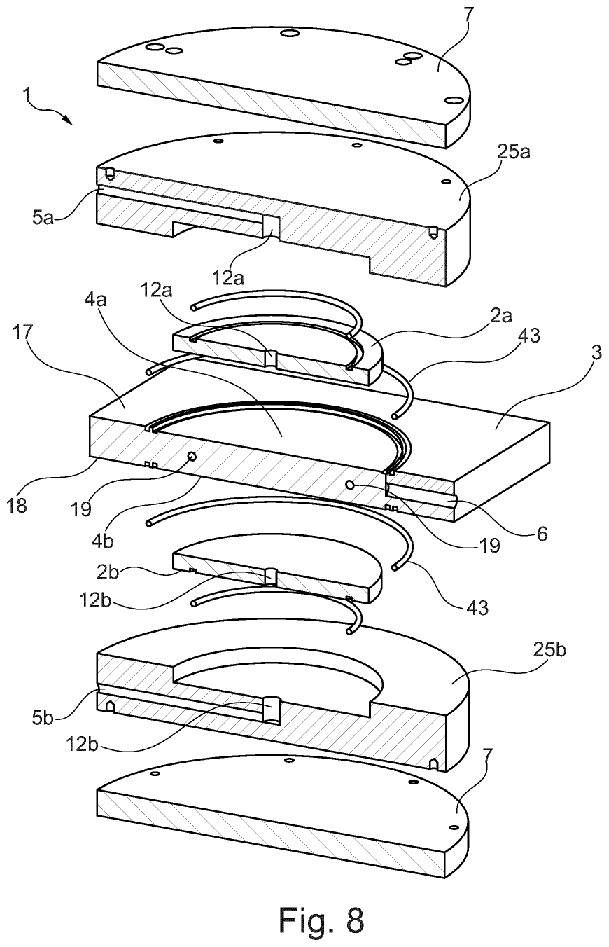

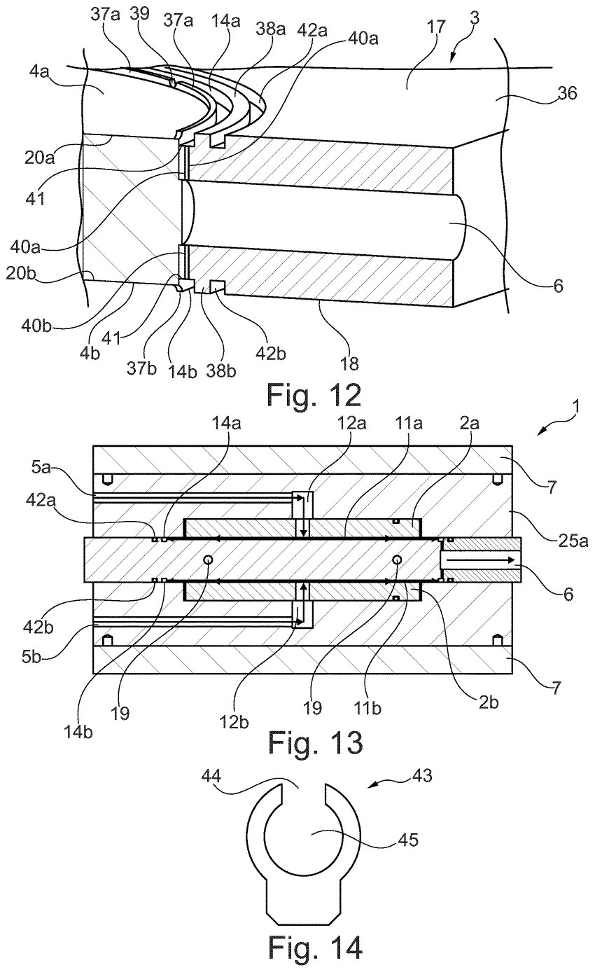

The construction of the second embodiment will be explained with reference to the figures: FIGS. 8 and 11 being a sectional and exploded view of the generator 1 shown in FIG. 10. FIG. 12 being an enlarged section of the outlet gas area. The flow of the gas is shown in FIG. 13.

The generator 1 comprises one LVE 3—placed in the middle of the generator 1 and on either side of the LVE 3 comprising the same inner components of the generator 1 as explained above. An isolator 25—first isolator 25a and second isolator 25b—is placed on opposite sides of the LVE 3. An inlet gas port 5—a first inlet gas port 5a and a second inlet gas port 5b—is placed in each an isolator 25a,25b as explained above. They each lead to their own inlet duct 12—a first inlet duct 12a and a second inlet duct 12b—which end up in the middle of each a corona chamber 11; a first corona chamber 11a and a second corona chamber 11b. Each corona chamber is delimited by a HVE 2, a first HVE 2a and a second HVE 2b and a dielectric, a first dielectric 4a and a second dielectric 4b.

A lid 7 is placed on opposite sides of the two isolators 25a,25b.

The outlet gas port 6—placed in the LVE 3 leads generated ozone gas out of the generator.

The LVE comprises integrated cooling channels 19 for cooling the ozone gas and the first LVE surface 17 and the opposite second LVE surface 18.

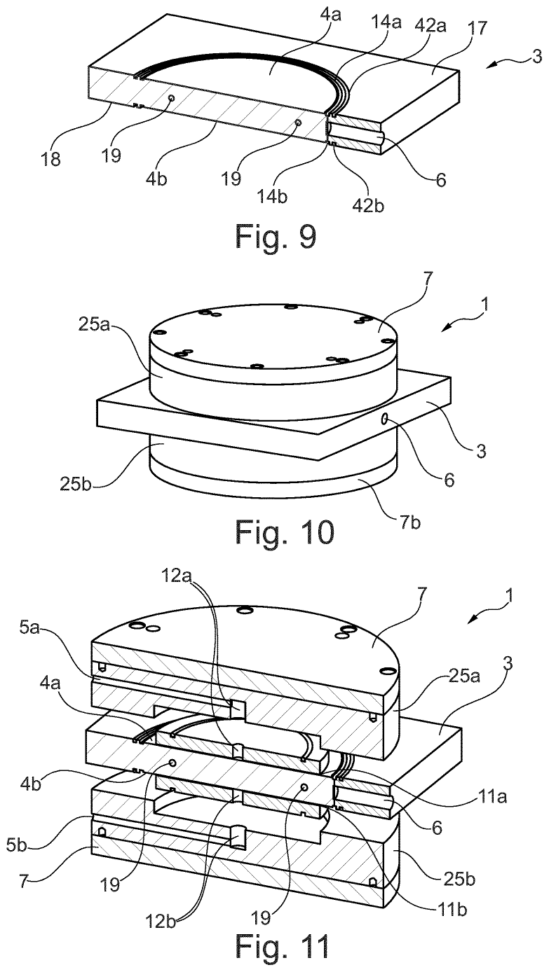

See FIGS. 8 and 9 and FIG. 12. Each surface is constructed as explained above that is:

The first surface of the LVE 17 turning towards the first HVE 2a/first isolator 25a comprises two in the periphery placed recesses a first outlet recess 14a and a first seal recess 42a placed in a distance from the first inlet duct 12a and encircling the first inlet duct 12a in its entire circumference. The first outlet recess 14a guides the ozone gas to the outlet gas port 6 placed in the cooled LVE 3.

A first communication channel 40a—FIG. 12—is placed in the bottom 41 of the first outlet recess 14a and connects the first outlet recess 14a with the outlet gas port 6.

The first seal recess 42a is encircling the first outlet recess 14a and a sealing member is placed in said first seal recess 42a.

The first outlet recess 14a is a circular closed recess encircling the first inlet duct 12a and placed with a radius R from the center of the first inlet duct 12a. The first outlet recess 14a is open at the top but closed by the first isolator 25a covering the top-opening of the first outlet recess 14a. A surface area of the surface of the LVE 3 turning towards the first HVE 2a is in a first inside-area 20a placed inside the first outlet recess 14a and is lowered in relation to an area 36 placed outside the first outlet recess 14a. It is clearly seen in FIG. 12. The first dielectric 4a covers the entire first inside-area 20a. The first inside area 20a is a circular lowered area corresponding to the extension of the first dielectric 4a. The dielectric is fully supported throughout its extent.

A first inside edge 37a is delimiting the first inside area 20a towards the first outlet recess 14a. Openings 39 in the first inside edge 37a are providing a gas communication between the first inside area 20a/first corona chamber 11a and the first outlet recess 14a.

The first seal recess 42a is a circular enclosed recess delimited from the first outlet duct 14a by a first seal edge 38a and encircling the first outlet recess 14a.

The second surface of the LVE 17 turning towards the second HVE 2b/second isolator 25b comprises two in the periphery placed recesses a second outlet recess 14b and a second seal recess 42b placed in a distance from the second inlet duct 12b and encircling the second inlet duct 12b in its entire circumference. The second outlet recess 14b guides the ozone gas to the outlet gas port 6 placed in the cooled LVE 3.

A second communication channel 40b is placed in the bottom 41 of the second outlet recess 14b and connects the second outlet recess 14b with the outlet gas port 6.

The second seal recess 42b is encircling the second outlet recess 14b and a sealing member is placed in said second seal recess 42b.

The second outlet recess 14b is a circular closed recess encircling the second inlet duct 12b and placed with a radius R from the center of the second inlet duct 12b. The second outlet recess 14b is open at the top but closed by the second isolator 25b covering the top-opening of the second outlet recess 14b. A surface area of the surface of the LVE 3 turning towards the second HVE 2b is in a second inside-area 20b placed inside the second outlet recess 14b and is lowered in relation to an area 36 placed outside the second outlet recess 14b. It is clearly seen in FIG. 12. The second dielectric 4b covers the entire second inside-area 20b. The second inside area 20b is a circular lowered area corresponding to the extension of the second dielectric 4b. The dielectric is fully supported throughout its extent.

A second inside edge 37b is delimiting the second inside area 20b towards the second outlet recess 14b. Openings 39 in the second inside edge 37b are providing a gas communication between the second inside area 20b/second corona chamber 11b and the second outlet recess 14b.

The second seal recess 42b is a circular enclosed recess delimited from the second outlet duct 14b by a second seal edge 38b and encircling the second outlet recess 14b.

Referring to FIG. 13 the flow of the gas will be explained. The oxygen rich gas is led into the first and second inlet gas port 5a,b and directed to the first and second inlet duct 12a,b to and further respectively to first and second corona chamber 11a,b. The gas is now flowing from the center to the periphery of the first and second corona chamber 11a,b respectively. Here it escapes though openings 39 in the first and second inside edge 37a,b to respectively the first and second outlet recess 14a,b. From here the ozone is led through the first and second communication channel 40a,b (see FIG. 12) to the outlet gas port 6 placed in the cooled LVE 3.

The generator is sealed with O-rings placed in recesses. One of them being the first 42a and second 42b seal recess sealed with an O-ring. Another seal is between the first 2a and second 2b HVE and the first and second isolator 25a, b. A circular recess is placed in the surface of the first 2a and second 2b HVE and an O-ring is pressed into each of the recesses for sealing.

The electricity is led to a connector part of both the HVE 2a,b through an opening in each of the isolators 25a,b. A high voltage between the first and the second HVE 2a,b and the LVE 3 is established.

Generally, one side of the ceramic plates 4a,4b is supported by the LVE 3 (ground electrode) in the full extension. The support may be a directly support the two surfaces touching each other or it may be indirectly by having for instance a thin metal net/plate incorporated between them. The LVE is made in pure aluminum and the dielectrics are preferably made in a ceramic material Al₂O₃ or another non-conductive material. The isolators are made in an isolating material such as Teflon® while the HVEs preferably are made in pure aluminum.

Due to the gas in the second embodiment is running over two HVE and thereby providing two corona chambers separated from each other and producing ozone the utilization factor is very high. A lot of ozone is produced compared with the known devices using the same amount of oxide.

The dielectrics are in the examples shown as ceramic plates. However, they could also be coatings applied on the surface of the LVE and with an extension as explained for the plate-formed dielectrics.

Referring to FIG. 14 the sealing member 43 is an O-ring with a circular circumferential opening 44 in the surface communicating with a circular circumferential inner cavity 45. In the cavity 45 a metallic ring (not shown) is placed.

The invention sees to that an excellent cooling of the ozone gas takes place due to the inventive construction of the LVE 3 placed in the inventive generator 1. The cooling effect takes place due to the cooling channels placed inside the LVE. Further the number of chambers the ozone gas has to pass is reduced reducing the risk for leak.

1. An ozone generator (1) for generating ozone comprising at least one high voltage electrode (HVE) (2,2a,2b) having a first HVE surface (22), an opposite second HVE surface (23);
one low voltage electrodes (LVE) (3), comprising a first LVE surface (17) and an opposite second LVE surface (18),
the generator (1) further comprises at least one dielectric (4,4a,4b) and at least one electric isolator (25,25a,25b),
the generator (1) further comprises at least one inlet gas port (5,5a,5b) and at least one inlet duct (12,12a, 12b) for leading oxygen rich gas into the generator (1) and one outlet gas port (6) for leading generated ozone gas out of the generator (1),
the generator (1) further comprises at least one corona chamber (11,11a, 11b) placed between the dielectric (4) and the HVE (2) and adapted to develop ozone,
the at least one dielectric (4,4a,4b) comprises a first surface (9) turning towards the first HVE-surface (22,) and an opposite second surface is turning towards the LVE surface (17,18), the oxygen is led through the inlet gas port (5,5a,5b) to the inlet duct (12, 12a, 12b),
the LVE (3) comprises integrated cooling channels (19) for cooling the ozone gas, characterized in that
the inlet duct (12,12a, 12b) ending in a center portion (13) of the corona chamber (11,11a, 11b), and at least one surface of the LVE (3) comprises one in the periphery placed outlet recess (14,14a, 14b), which faces in the same direction as the first surface (9) of the dielectric (4,4a,4b),
the outlet recess(es) (14,14a, 14b) placed in a distance from the inlet duct (12,12a, 12b) and encircling the inlet duct (12,12a, 12b) in its entire circumference, and the at least one outlet recess (14,14a, 14b) is adapted to guide the ozone gas to the outlet gas port (6) placed in the cooled LVE (3).

2. An ozone generator (1) according to claim 1 characterized in that
the at least one outlet recess (14,14a, 14b) is a circular closed first recess encircling the inlet duct(s) (12,12a, 12b) and placed with a radius R from the center of the inlet duct(s) (12,12a, 12b).

3. An ozone generator (1) according to claim 1 characterized in that the surface(es) of the LVE (3) turning towards the HVE (2) in an inside-area (20,20a,20b) placed inside the outlet recess (14,14a, 14b) is/are lowered in relation to an area (36) placed outside the outlet recess (14,14a, 14b), and that the dielectric (4,4a,4b) covers the entire said inside-area (20,20a,20b).

4. An ozone generator (1) according to claim 3 characterized in that the inside area(s) (20,20a,20b) is/are a circular lowered area corresponding to the extension of the dielectric(s) (4,4a,4b), whereby the dielectric(s) is/are fully supported throughout its/their extent.

5. An ozone generator (1) according to claim 3 characterized in that an inside edge (37,37a,37b) is delimiting the inside area(s) (20,20a,20b) towards the outlet recess (14,14a, 14b), and openings (39) in the inside edge (37,37a,37b) are providing a gas communication between the inside area(s) (20,20a,20b) and the outlet recess(es) (14,14a, 14b).

6. An ozone generator (1) according to claim 1 characterized in that a communication channel (40,40a,40b) placed in a bottom (41) of the at least one outlet recess (14,14a, 14b) connects the outlet recess(es) (14, 14a, 14b) with the outlet gas port (6).

7. An ozone generator (1) according to claim 1 characterized in that a seal recess (42,42a,42b) is encircling the outlet recess(es) (14,14a, 14b), and a sealing member (43) is placed in said seal recess(es) (42,42a,42b).

8. An ozone generator (1) according to claim 7 characterized in that the sealing member(s) (43) is/are an O-ring with a circumferential opening (44) in the surface communicating with a substantially cylindrical internal cavity (45), in said cavity (45) a metallic ring is placed.

9. An ozone generator (1) according to claim 1 characterized in that the seal recess(es) (42,42a,42b) is/are a circular enclosed recess(es) delimited from the outlet recess(es) (14,14a, 14b) by a seal edge (38,38a,38b).

10. An ozone generator (1) according to claim 1 characterized in that the corona chamber(s) (11,11a, 11b) is/are adapted to maintain a high voltage between one HVE (2,2a,2b) and the LVE (3),
and that a high voltage is applied to the at least one HVE (2,2a,2b) by an electrical connection—such as a wire—to a connector part of said HVE (2,2a,2b).

11. An ozone generator (1) according to claim 1 characterized in the second surface of the dielectric(s) (4,4a,4b) is/are directly or indirectly supported in its/their full extension by the LVE-surface(s) (17,18), and that the dielectric(s) (4,4a,4b) is/are a continuous unbroken plate(s).

12. An ozone generator (1) according to claim 1 characterized in the HVE(s) (2a,2b) comprise(s) a circumferential edge delimiting the extension of the HVE(s) (2,2a,2b), and that the dielectric(s) (4,4a,4b) comprise(s) a circumferential edge delimiting the extension of dielectric(s) (4,4a,4b), and the delimiting edge of the dielectric(s) (4,4a,4b) in the whole periphery extends all over the delimiting edge of the HVE(s) (2,2a,2b).

13. An ozone generator (1) according to claim 1 characterized in the at least one corona chamber (11,11a, 11b) is/are delimited at one side by the at least one dielectric (4,4a,4b) placed on the cooled LVE (3) and at the opposite side by the HVE (2,2a,2b), and at the periphery by an edge with openings (39) said edge is an integrated part of the cooled LVE (3).

14. An ozone generator (1) according to claim 1 characterized in that the generator (1) comprises one HVE (2), one dielectric (4), one corona-chamber (11), one LVE (3), one inlet gas port 5, one inlet duct (12), one electric isolator (25) and one outlet gas port (6), said the LVE (3) comprises integrated cooling channels (19) for cooling the ozone gas, and one surface of the LVE (3) comprises one in the periphery placed outlet recess (14) placed in a distance from the inlet duct (12) and encircling the inlet duct (12) in its entire circumference, and the outlet recess (14) is adapted to guide the ozone gas to the outlet gas port (6) placed in the cooled LVE (3).

15. An ozone generator (1) according to claim 1 characterized in the generator comprises two HVE (2) a first HVE (2a) and a second HVE (2b) and two dielectric (4) a first dielectric (4a) and a second dielectric (4b), two inlet gas ports (5) a first inlet gas port (5a) and a second inlet gas port (5b) for leading oxygen rich gas into each of its corona chamber (11) a first corona chamber (11a) and a second corona chamber (11b),
two electric isolators (25) a first isolator (25a) and a second isolator (25b), and one LVE (3),
the LVE (3) comprises integrated cooling channels (19) for cooling the ozone gas and the surfaces of the LVE (3)—the first LVE surface (17) and the opposite placed second LVE surface (18)—each comprising a peripheric placed outlet recess (14)—a first outlet recess (14a) and a second outlet recess (14b)—placed in a distance from each inlet duct (12)—a first inlet duct (12a) and a second inlet duct (12b)—each encircling the inlet ducts (12a, 12b) in their entire circumferences and for guiding the ozone gas to the outlet gas port (6) placed in the cooled LVE.

16. Method for generating ozone from an oxygen rich gas by leading the oxygen rich gas into an ozone generator (1) comprising at least one high voltage electrode (HVE) (2,2a,2b) having a first HVE surface (22), an opposite second HVE surface (23);
one low voltage electrodes (LVE) (3), comprising a first LVE surface (17) and an opposite second LVE surface (18),
the generator (1) further comprises at least one dielectric (4,4a,4b) and at least one electric isolator (25,25a,25b),
the generator (1) further comprises at least one inlet gas port (5,5a,5b) and at least one inlet duct (12,12a, 12b) for leading oxygen rich gas into the generator (1), and one outlet gas port (6) for leading generated ozone gas out of the generator (1),
the generator (1) further comprises at least one corona chamber (11,11a, 11b) developing ozone placed between the dielectric (4,4a,4b) and the HVE (2),
the at least one dielectric (4,4a,4b) comprises a first surface (9) turning towards the first HVE-surface (22) and an opposite second surface is turning towards the first LVE surface (17), the oxygen is led through the inlet gas port (5,5a,5b) to the inlet duct (12,12a, 12b), and the LVE (3) comprises integrated cooling channels (19) for cooling the ozone gas characterized in that
the gas is flowing from a center to the periphery of the corona chamber (11,11a, 11b),
that the gas is flowing through one in the periphery placed outlet recess (14, 14a, 14b) placed in a distance from the inlet duct (12,12a, 12b) in at least one of the surfaces of the LVE (3)—the first and the second LVE surface (17,18)—and encircling the inlet duct (12,12a, 12b) in its entire circumference, and whereby the ozone gas is guided to the outlet gas port (6) placed in the LVE (3), said LVE (3) including the outlet recess(es) (14,14a, 14b) are cooled by the cooling channels (19) integrated in the LVE (3) by said cooling the leaving ozone gas is cooled.

17. Method according to claim 16 characterized in that the gasflow in the outlet recess(es) (14,14a, 14b) flows circular encircling the inlet duct(s) (12a, 12b,12c), and the circular gasflow is placed in a radius R from the center of the inlet duct(s) (12a, 12b, 12c).

18. Method according to claim 16 characterized in that the gas flows from an inside-area (20,20a,20b) placed inside the outlet recess(es) (14,14a, 14b) through openings (39) placed in an inside edge (37,37a,37b) delimiting the inside-area(s) (20,20a,20b) and from here flows towards the outlet recess(es) (14, 14a, 14b).

19. Method according to claim 16 characterized in that the gas flows form the outlet recess(es) (14, 14a, 14b) to a communication channel (40,40a,40b) connecting the outlet gas port (6) with a bottom of the outlet recess(es) (14,14a, 14b).

20. (canceled)
